(19) United States
(12) Patent Application Publication
(10) Pub. No.: US 2020/0352159 A1
(43) Pub. Date: Nov. 12, 2020

(54) Process for Preparation of Broadcast Granules

(71) Applicant: GRANULAR PRODUCTS ASSETS PTY LTD, Orange, New South Wales (AU)

(72) Inventors: Philip PENTLAND, Flemington, Victoria (AU); Mathew NEMARIC, Altona Meadows, Victoria (AU); Anthony FLYNN, Wandana Heights, Victoria (AU)

(21) Appl. No.: 16/640,546

(22) PCT Filed: Aug. 21, 2018
(86) PCT No.: PCT/AU2018/050884

§ 371 Date: Feb. 20, 2020

(30) Foreign Application Priority Data
Aug. 21, 2017 (AU) 2017903355
Aug. 21, 2017 (AU) 2017903356

(51) Int. Cl. A01N 25/14; A01N 25/30; A01N 43/82; A01N 25/08; A01N 25/22

(52) U.S. Cl. CPC A01N 25/14; A01N 25/30; A01N 25/22; A01N 25/08; A01N 43/82

(57) ABSTRACT

A process for preparing a broadcast granular pesticide composition comprising:

combining a pesticide active composition, powdered carrier composition and water in an amount of at least 5% water based on the weight of the total of the pesticide composition and powdered carrier composition, to form a pliable moist mixture; and
forming the pliable moist mixture into granules;
wherein the carrier composition comprises hydratable calcium sulfate whereby hydration of the hydratable calcium sulfate following granule formation reduces the free water content of the granules to produce hardening of the granules.

### FIELD

This invention relates to a process for preparation of pesticidal broadcast granules and also relates to granules made using such processes and the use of the granules in controlling pests in an area of land. More specifically, the invention relates to a granular composition containing a pesticide for use in the form of broadcast granules and methods for their use in the broadcast delivery of pesticides to an area of land.

### BACKGROUND OF INVENTION

Pesticides are widely used in control of pests in areas of land by both private and commercial operators. Pesticide compounds may be used alone; however, usually they are formulated as dust, granules, wettable powder, flowable powder, emulsion concentrates, concentrated emulsions, microcapsules, solution concentrates, oils, aerosols, etc., using techniques well known in the art. To improve or stabilize the effects of the pesticide, the pesticide is blended with suitable adjuvants and then used as such or after dilution if necessary. The present invention is directed towards dry broadcast granules, and towards methods of preparing such granules, which can be applied with a dry spreader to a target area by methods such as aerial broadcasting. These granules release their pesticide load when exposed to water, for example, rain, irrigation or by deposition in a body of water.

Broadcast granules may be used to deliver pesticides to hard-to-access locations such as remote areas and swamps that contain mosquito-breeding pools by aerial broadcasting from suitably equipped aircraft. Granules for dry broadcast of pesticide possess certain specific characteristics which are not necessary in compositions designed for admixing in large volumes of water such as tank mixes and ultimately sprayed upon sites to be treated. Compositions for mixing with water are generally formulated as wettable powders or water dispersible granules, as opposed to the dry broadcast granules. Characteristics which are important for dry broadcast granules include hardness and an ability to maintain integrity upon normal, commercial handling and storage in a dry spreading operation and yet be capable of quickly delivering the active pesticide content on exposure to water, such as from rain, irrigation or when delivered onto a body of water. A problem associated with broadcast granules is the inability of the active pesticide to leave the granule on contact with water such as rain, irrigation water or when deposited in a body of water. The inability to leave the carrier in an effective amount and promptly following contact with water is common, for example when the active chemical agent(s) absorbs too deeply into the inert carrier, the active chemical agent(s) is too tightly adhered to the inert carrier or the carrier is too hydrophobic to readily allow the ingress of water.

Tebuthiuron (1-(5-tert-Butyl-1,3,4-thiadiazol-2-yl)-1,3-dimethylurea) is a non-selective broad spectrum herbicide of the urea class. It is used to control weeds, woody and herbaceous plants, and sugar cane. It would be useful to provide an effective process for preparation of broadcast granules of tebuthiuron which does not require thermal drying and allows effective amounts of the herbicide to be released on contact with water

Broadcast granules are generally prepared by adding water to a mixture of finely dispersed components such as pesticide active, carrier and adjuvants followed by granule formation and drying, generally at elevated temperature. For example, Australian application 2014256380 (Granular Products) describes a broadcast granule comprising Tebuthiuron herbicide, in which a feature of the process for preparation of the granule involves addition of water to finely divided solid granule components, typically at a level of more than 5% (and up to 15%) by weight of the moist granules. These moist granules are too soft for storage and commercial use, and in order to obtain granules of sufficient hardness, much of the moisture needs to be removed in a heat-assisted drying step. This heat-assisted drying step may be energy-intensive and/or capital-intensive and contributes significantly to granule manufacturing costs. Heat-assisted drying may also degrade active agents located inside the granules, particularly if these active agents are thermally labile.

It would be of great benefit to provide a method forming broadcast granules which allowed granules to be formed without a requirement for the energy intensive drying processes so the preparation could, for example, take place at room temperature or within 10° C. of room temperature.

### SUMMARY OF INVENTION

There is provided, in accordance with the invention, a process for preparing a broadcast granular pesticide composition comprising:

combining a pesticide active component, powdered carrier component and water in an amount of at least 5 wt % water based on the cumulative weight of the pesticide active component and powdered carrier component; and

forming the mixture into granules;

wherein the carrier component comprises hydratable calcium sulfate whereby hydration of the hydratable calcium sulfate following granule formation reduces the free water content of the granules and produces hardening of the granules.

The hydratable calcium sulfate is preferably present in an amount sufficient to reduce the free water content of the granules as a result of hydration and to achieve an average crush strength of at least 150 g and preferably at least 500 g. The crush strength may generally be achieved without the intensive heat assisted drying conditions previously used and generally the temperature during the process may be within 15° C. of ambient temperature such as within 10° C. of ambient temperature. In one set of embodiments the process temperature is in the range of from 5° C. to 40° C. such as from 10° C. to 30° C. The crush strength of the granules of the invention is an advantage which was not expected with use of a relatively low proportion of hydratable calcium sulfate such as the hemihydrate. Granules of relatively high crush strength perform more effectively in storage and aerial broadcasting. For example they are less readily deformed on storage are subject to lower fines formation on storage and exhibit excellent ballistic properties when distributed from aircraft resulting in more accurate distribution and less off-target scattering.

Where referred to herein the free water in the granules is water content that can be measured using the NIR methodology (an absolute measure). In the NIR method the granule sample is placed on a tray, IR irradiation is directed at the granules, directly heating free water, and weight loss (associated with water evaporation) is measured. A 4 hr irradiation period is used. Water which is not free water may be bound within the granules as water of hydration or in other ways. In one further embodiment the hydratable calcium sulfate is present in an amount to reduce the free water content of the granules (measured using the NIR method) by at least 30% preferably at least 50% and more preferably at least 65% as a result of hydration of the hydratable and hardening of the calcium sulfate.

The term broadcast granules refers to granules which are broadcast or spread in granular form onto the site of action of the pesticide. Broadcast granules are not dissolved or dispersed in a liquid carrier such as water or organic solvent prior to being applied onto the site of action. Generally speaking the active pesticide leaves the granules as a result of water contact with the granules at the site of action. The water may be from rain, irrigation or from the granules being broadcast onto a body of water, that is significant accumulation of water on the earth's surface which is infested with pests such as weeds, insects, larvae or the like a including pools of water such as ponds, swamps, wetlands and canals Generally the granules of the invention undergo a loss of integrity as a result of fragmentation into two or more, such as three of more, fragments when immersed in water at 20° C. for a period of up to 2 hours such as up to one hour.

In a preferred aspect the mixture is of consistency suitable for extrusion and the granules are formed by extrusion.

The amount of hydratable calcium sulfate will depend on, among a range of considerations, the water content. Typically the amount of hydratable calcium sulfate is sufficient to develop a crush strength of at least 150 g and preferably at least 500 g. This may result in a reduced free water content of the granules (as measured by the NIR method) to no more than 4% w/w, preferably no more than 3% w/w based on the granule composition.

In a preferred set of embodiments the composition further comprises a hardening accelerator which accelerates the hydration of the hydratable calcium sulfate to provide additional control over the rate of hardening of the granules. In one set of embodiments the accelerator is a metal sulfate salt such as alkaline earth metal sulfates and zinc sulfate. Calcium sulfate when used as an accelerator of hardening is in the form of gypsum (calcium sulfate dihydrate which is not hydratable). Hydratable calcium sulfate is not considered a hardening accelerator for the purposes of the present invention.

In accordance with a preferred embodiment the invention, a process for preparing a broadcast granular composition of a pesticide selected from tebuthiuron, hexazinone and flupropanate comprising:

combining an active component comprising the pesticide, powdered carrier component and water in an amount of at least 5% water based on the weight of the composition; and

forming the mixture into granules;

wherein the carrier component comprises hydratable calcium sulfate whereby hydration of the hydratable calcium sulfate following granule formation reduces the free water content of the granules and produces hardening of the granules.

The more preferred pesticide is at least on selected from the group consisting of tebuthiuron, hexazinone, Bt and flupropanate and most preferably is at least one of tebuthiuron, hexazinone and flupropanate, and in particular tebuthiuron.

When present it is preferred that the weight ratio of hardening accelerator to hydratable calcium sulfate is in the range of from 1:10 to 10:1, preferably from 1:5 to 5:1 and more preferably from 1:3 to 3:1 such as from 1:2 to 2:1. The optimum accelerator to hydratable calcium sulfate ratio will depend on the specific composition and the amount of hydratable calcium sulfate hemihydrate. Lower amounts of accelerator will increase the time it takes for the granules to achieve a suitable hardness for packaging and distribution. Preferably the granules will achieve a crush strength of at least 150 g and preferably at least 500 g within a period of 10 hours, preferably within a period of 5 hours from granule formation, preferably within a period of 2 hours. The amount of hydratable calcium sulfate and activator will also depend of the amount of water used and is preferably regulated to control the consistency of the granules so as to provide a rounded shape and achieve sufficient hardness for storage and handling within a suitable time for processing at the required production rate.

In a further aspect the invention provides a method for controlling pests in an area of land comprising the pests comprising broadcasting the granules onto the land wherein the pesticidal active is active against the pests. Examples of pests which may be controlled with suitable actives using the process of the invention include weeds, insects, molluscs, nematodes, rodents or the like pests.

### DETAILED DESCRIPTION

The carrier component used in the preparation of the broadcast granules comprises hydratable calcium sulfate. The term hydratable calcium sulfate refers to anhydrous or partly hydrated calcium sulfate, particularly calcium sulfate hemihydrate and allows some of the water used in forming the mixture to be converted from free water to bound water of hydration of the calcium sulfate. This hydration reduces the free water content of the granules and produces hardening of the granules.

The mixing of the components and formation of granules takes place while the composition is relatively soft before hydration leads to hardening beyond the point where the granule formation process may readily take place. The rate of hydration and hardening will depend on the proportion of components and the type of adjuvants such as accelerator and the temperature. Generally speaking the rate of hydration allows the process of formation of the granules to be conducted at or near room temperature and generally at temperatures in the range of 5° C. to 40° C. and preferably from 10° C. to 30° C. It is preferred that the composition is not be heated although it will be appreciated that depending on the content of the granules exothermic or endothermic reactions associated with hydration are possible. Typically the composition is not heated to more than 50° C. and preferably not more than 40° C. during the process.

The hydratable calcium sulfate is preferably present in an amount sufficient to achieve average crush strength of at least 150 g preferably at least 250 g, more preferably at least 350 g and most preferably at least 500 g. The crush strength may generally be achieved without the intensive heat assisted drying conditions previously used and generally the temperature during the process may be within 15° C. of ambient temperature such as within 10° C. of ambient temperature. In one set of embodiments with temperature is in the range of from 5° C. to 40° C. such as from 10° C. to 30° C.

Where used herein the term crush strength refers to the lowest compressive stress that causes the granules to fracture. To determine crush strength granules were placed on a balance and individually crushed firmly with a spatula or other flat surface, by increasing the force applied. The maximum force immediately before breakage was recorded as the crush strength. The median of 15 to 20 measurements was reported and the average determined.

In a preferred set of embodiments the hydratable calcium sulfate component is added in an amount of from 2% to 25%, preferably 3% to 25% (more preferably from 3% to 20%, more preferably 3% to 15% and still more preferably from 4% to 15%) by weight based on the dry weight of the components of the composition. Thus typically the ratio of granule weight to hydratable calcium sulfate is at least 3:1, preferably at least 4:1, such as at least 6:1 or at least 8:1. The ability to achieve high strength (such as at least 150 g preferably at least 250 g, more preferably at least 350 g and most preferably at least 500 g) with relatively low loading of hydratable calcium sulfate allows a high payload of active to be included or other materials such as filler, fertiliser surfactant or other materials to be used in significant amounts. The high payload of active allows the costs of storage and transport to be minimised which is of great commercial advantage in aerial broadcasting operations where weight limitations are often imposed and the cost of equipment and/or fuel make efficient delivery important to minimising costs. Surprisingly heat assisted drying of the granules is not required despite the use of low amounts of calcium sulfate hemihydrate which are not sufficient to account for much of the water by further hydration to form gypsum.

The term hydratable calcium sulphate refers to a calcium sulphate moiety wherein the average degree of hydration (on a moles water per mole calcium sulphate basis) is less than 2, preferably less than one, more preferably about 0.5.

In a particularly preferred aspect the hydratable calcium sulfate is in the form of the hemihydrate. This material has the formula CaSO₄.(nH2O), where 0.5≤n≤0.8 and is commonly referred to as plaster of Paris. The presence of the hydratable calcium sulfate particularly in the amounts described above allows the granules to develop a high crush strength making them particularly suitable for use as broadcast granules for aerial distribution and yet release the active payload within the granule reasonably rapidly on contact with water. The hydratable calcium sulfate is preferably present in an amount sufficient to achieve an average crush strength of at least 150 g preferably at least 250 g, more preferably at least 350 g and most preferably at least 500 g. The crush strength may generally be achieved without the intensive heat assisted drying conditions previously used to form pesticide granules and generally the temperature during the process may be within 15° C. of ambient temperature such as within 10° C. of ambient temperature. In one set of embodiments with temperature is in the range of from 5° C. to 40° C. such as from 10° C. to 30° C.

When determining the amount of hydratable calcium sulfate for a specific formulation a number of factors need to be balanced. The amount of hydratable calcium sulfate needs to be limited so as to allow a sufficient carrying capacity for the active pesticide in the granule. Also, the hydratable calcium sulfate controls the hardness of the granule and should be controlled, taking into consideration the requirement for substantial release of the active on contact with water. On the other hand the amount of hydratable calcium sulfate is generally sufficient to achieve a required level of hardness within a convenient time frame for providing a granular composition suitable for packing and delivery to the site of use. As mentioned above we have found that the objective of providing effective rapid release of pesticide while also providing sufficient hardness for good storage and distribution is provided when the amount of the hydratable calcium sulfate is limited to from 2% to 25%, (preferably 3% to 25% more preferably from 3% to 20% such as 3% to 15% or 4% to 15%) by weight based on the dry weight of the components of the composition. Thus typically the ratio of granule weight to hydratable calcium sulfate is at least 2:1, preferably at least 4:1, more preferably at least 10:1, such as at least 12:1.

Water may be added to the active and filler components, which are typically in powder form, as part of the process for the formation of granules. Water may be added as part of an aqueous composition comprising other materials such as plant stimulants fertiliser or pesticide. The amount of water is sufficient to bind the components to for a pliable mixture which may be of dough consistency. It will be understood by those skilled in the art that the optimal amount of water can be determined having regard to the method of granule formation such as pan granulation, extrusion, roll extrusion, pelletisation or the like. Generally the amount of water will be at least 5% by weight based on the weight of the granule components, such as from 5% by weight to 25% by weight based on the weight of the granule components. In one set of embodiments the water is added to the components, preferably components in powder form, to form the pliable mixture in an amount in the range of from 8% to 20% (such as 10% to 20%) by weight, based on the weight of the components. The active agent and filler may comprise water in small amounts which form part of the active agent component and/or filler. The amount of water present in these components will generally be at a level to allow the components to be in a flowable powder form. The amount of water in the active agent component will generally be no more than about 10% by weight preferably no more than about 5% by weight of the component such as no more than 3% by weight.

As used herein, the term “granulation” refers to the process of agglomerating powder particles into larger particles called granules that contain the active pesticide ingredient. The term “moist granulation” refers to any process comprising the steps of addition of water to a powder blend of materials. The materials used in the moist granulation include the active pesticide ingredient which is preferably a solid in a powder form. The powder used in forming the moist mixture generally includes the active and carrier. Powder can be generated by grinding and the particle size distribution that results from the grinding step may influence the properties of the formulation. The preferred average particle diameter of the powder is no more than 200 microns, preferably no more than 100 microns. The active pesticide ingredient is mixed with the carrier (also in powdered form) which includes hydratable calcium sulfate. The presence of the hydratable calcium sulfate provides hydration and binding of at least a portion of the free water used in forming the moist mixture.

The hydration results in the granules being transformed from a relatively soft consistency to a hard granule following granule formation. The granules may be retained prior to packaging (for example on a surface at a shallow depth) following granule formation to allow hardening as a result of the hydration process to take place.

Typically the hydratable calcium sulfate will reduce the free water content by at least 30% as a result of hydration, preferably at least 50% and more preferably at least 65%. The reduction in free water content results at least in part from hydration and other binding of water and does not generally require heating to dry the granules.

The moist mixture formed prior to or during granulation will generally comprise other excipients, such as surfactants, additional carrier component, or lubricants, in the powder blend.

In one embodiment the components include components chosen from the group consisting of pesticide active ingredient, hydratable calcium sulphate, accelerator additive, surfactant, additional carrier, binding agent and water. The term hydratable calcium sulphate refers to a calcium sulphate moiety wherein the average degree of hydration (on a moles water per mole calcium sulphate basis) is less than two, preferably less than one, more preferably about 0.5 to about 0.8.

Water may be added during one or more stages in process. The water quantity used in the mixing process will depend on the nature of the components and their proportions (refer to GP prior art AU 2015100573, which is incorporated by reference) and the specific method used for granulation such as pan granulation, extrusion, roll extrusion, spheronisation and combinations thereof such as the combination of extrusion and spheronisation. In one embodiment the water is added to a dry blend formed from the solid powder components, such as in an amount of added water in the range of from 5-20% by weight based on dry-blend weight. The water may be added in the form of liquid water, an aerosol or as a fine spray of water. It is preferred that water is added at a temperature of no more than 40° C. and preferably from 10° C. to 30° C. The quantity of water added prior to granule formation may be determined by observing the granule-formation. If the granules that emerge from the granule-formation are too crumbly, more water is added to the component mixture. If the granules that emerge from the granule-forming unit operation are deformed or sticky, a drier component blend (or less water) is added to the component mixture.

In one preference the process steps are carried out under conditions where delta-T is in the range of about 2° C. to 8° C.

Delta-T is the difference between the dry-bulb temperature and the wet-bulb temperature in the environs of the equipment used for process including mixing of the components with water and formation of granules, preferably by extrusion of a moist paste. Without wishing to be bound by theory, it is believed that when delta-T is less than about 2° C., the ambient humidity is sufficiently high to compromise the activity of the hydratable calcium sulfate, particularly in the domain close to the surface of the moist mixture, or the surface of the granules during granule formation. When delta-T is greater than about 8° C., the ambient air is sufficiently dry to cause moisture loss. It is considered likely that a moisture inhomogeneity at the surface of moist mixture and/or granules leads to less desirable granule morphology in terms of reduced uniformity within or between granules. The issue of moisture inhomogeneity is more important in granule formation processes where the granule ingredients compromise modest amounts of hydratable calcium sulfate (e.g. less than 40% by weight of dry blend powder and greater than 2% by weight).

A range of granulation processes are known in the art which may be used in the process of the invention. Examples of granulation methods include pan granulation, pelletisation compaction, extrusion, spheronisation and combinations of these processes such as the combination of extrusion and spheronisation.

As used herein, the term “compaction” refers to a process for formulating a pesticidal composition in which the moist mixture is subjected to a compaction force such as through a press or roll compaction apparatus. In one embodiment, the moist mixture of components is processed in a high-pressure pelletiser. In one embodiment the process for forming the granules includes a first processing stage comprising low-pressure extrusion such as in a basket extruder.

In a preferred set of embodiments the pliable mixture is of consistency suitable for extrusion and the granules are formed by extrusion.

The granulation process may form a primary granule for example by extrusion that is shaped by a secondary process such as cutting and/or spheronisation to provide a more uniform shape and/or dimensions.

In a particularly preferred embodiment the granulation process comprises the preparation of the moist mixture followed by tumbling of the extrudate to produce granules. The term “extrudate” as used herein refers to the product of extrusion, which in preferred embodiments are cylindrical and which may be produced in cylindrical segments or continuous lengths and subsequently broken up into segments.

The extrudate may be subject to a tumbling action in a rotatable mixer such as a drum mixer, which may be cylindrical or narrowing taper to an opening and which may comprise baffles on the inner wall to promote rounding of the broken extrudate. In one aspect the tumbling or rolling period may be between 30 seconds to one hour. In the embodiment in which a rotatable drum is used the rate of rotation (not narrowly critical) may be from 1 to 100 rpm.

In a preferred embodiment the process of forming the granules comprises extrusion of the moist pliable mixture to form an extrudate followed by rolling of the extrudate to produce rounded granules.

Most preferably the granules are prepared from the moist mixture by extrusion followed by spheronisation. The technique generally involves extrusion of the moist mixture, breaking up the extrudate into segments and rounding the segments of extrudate into spheres (spheronisation). Hosokawa BEPEX GmbH (http://www.hosokawamicron.com) describes one example of the technique of low-pressure extrusion and spheronisation for the production of, rounded pellets.

In a particularly preferred embodiment the low pressure extrusion apparatus comprises (i) cylindrical extrusion chamber, (ii) counter-rotating rotors in the upper part of the feed hopper, (iii) a mixing and densification section proximal to the screen baskets, and (iv) screen baskets, which have an array of perforations for forming the extrusions. The dimension of the perforations and the wall thickness of the screen section may be chosen having regard to the desired particle dimensions following spheronisation. Spheronisation typically involves imparting an intense rolling movement to granules. In one embodiment, the shaping of granules involves the use of a spheroniser, such as a spinning disc spheroniser.

In one embodiment a fine water spray is applied to the granules in the spheroniser. Application of a fine spray can reduce crumb and powder formation and provide high yields of spherical granules. The spheroniser may be in the form of a rotating disc. In one embodiment water is applied as a spray onto the granules during the spheronisation process. The amount of water applied to the granules during spheronisation may, for example, be in the range of from 0.3% to 3% of the starting weight of granules in the spheroniser.

In one embodiment the components in the first processing stage include components chosen from the set consisting of active ingredient, hydratable calcium sulphate, accelerator additive as defined, dispersing agent, wetting agent, lubricating agent, additional carrier and binding agent. Water is combined with the components in this stage.

In one set of embodiments the pliable moist mix is granulated by extruding the moist mix using a low pressure basket extruder comprising basket orifice diameters in the range of from 1 mm to 4 mm to provide an extrudate and spheronising the extrudate to provide granules. In one set of embodiments the basket extruder comprises a cutting device outside of the basket to reduce the extrudate to a uniform length prior to spheronisation. The basket extruder may, and preferably will, comprise a perforated cylinder oriented with a vertical axis.

The extrusion orifices are preferably from about 1 mm in diameter to about 4 mm in diameter, preferably from 1.5 mm to 3 mm, more preferably 2 mm in diameter to 3 mm in diameter. Generally speaking the size range of 1 mm to 4 mm (preferably 1.5 mm to 3 mm) enables good ground coverage to be achieved by aerial broadcasting. Furthermore preparation of larger granules (i.e. larger than 4 mm required extrusion equipment with corresponding extrusion orifices resulting in less efficient extrusion and a higher population of deformed granules.

In one set of embodiments the cylindrical basket is rotated about the vertical axis and a counter rotating stirrer inside the cylinder forces moist crumb through the basket orifices. We have found that the preparation of granules of the desired morphology is enhanced when the basket extruder is provided with at least one stationary cutting blade (preferably at least two cutting blades such as at least 4 or at least 6 cutting blades) positioned adjacent the outside of the rotating basket.

Granules are formed from a pliable, moist mixture with much of the hardening process occurring following granule formation. It is therefore preferred to allow for a hardening period after granule formation and to minimise mechanical processing which would cause deformation or cohesion of the granules before sufficient hardening has occurred.

Generally the granules will be allowed to harden for a period of time without disruption until hardening has occurred to provide granules in a state where they are sufficiently hard to be further processed and handled. It is preferred that the granules be kept in shallow storage, preferably of depth no more than 10 cm, more, preferably no more than 5 cm until a crush strength of at least 150 g is obtained.

Generally the granules will be retained on a surface with the shallow granule depth for at least 5 minutes such as from 5 minutes to 240 minutes, preferably 5 minutes to 60 minutes prior to packaging.

Accordingly, in one embodiment, the process of the invention comprises maintaining the granules in a shallow collection for a period sufficient to allow hydration to provide hardening to a crush strength of at least 150 g; and packaging the granules, for example, in packages containing at least 500 g of granules such as packages of from 500 g to 100 kg of granules.

The granules preferably have an average aspect ratio of from 1 to 1.5. The aspect ratio is the ratio of the largest dimension of a granule divided by the smallest dimension. In one embodiment the granules have an average aspect ratio of from 1 to 1.3 such as from 1 to 1.2. In a further embodiment, the standard deviation of the distribution of individual particle aspect ratios throughout the sample is less than 0.4, preferably less than 0.3, more preferably less than 0.2 and most preferably less than 0.15.

In a preferred embodiment the granules of the composition preferably have a size wherein at least 70% w/w, preferably at least 80% w/w (more preferably at least 90% w/w and still more preferably at least 95% w/w) of the granules have an aspect ratio in the range of from 1 to 1.5 preferable from 1 to 1.2 and the weight average particle diameter in the range of from 1 mm to 4 mm (preferably 1.5 to 3.5 mm). This is particularly important for aerial broadcasting of the granules from an aircraft where it is important to obtain uniform coverage of the land to be treated with minimal packing volume of the composition.

The average crush strength (hardness) of the granules is preferably at least 150 g and is preferably at least 500 g. Conventionally hardness is lower when more water is retained within the granule, and granule hardness is greater when more water is removed by drying. The present invention, by contrast allows hardness to be provided (as determined by crush strength) by binding a at least some of the added free water as water of hydration of calcium sulfate.

In one set of embodiments the individual granules have an average density of greater than 1 g/ml, preferably greater than 1.05 g/ml.

As used herein, the term surfactant refers to agents capable of facilitating spread of water over the surface of the granule components and admitting water to the granule interior and facilitating reshaping of the granule. The surfactant component will generally accelerate delivery of the active from the granule in the presence of water. Surfactants may act as detergents, wetting agents, emulsifiers, foaming agents and/or disintegrants.

Generally speaking the surfactant component assists in performance of the granule once broadcast onto land to be treated with pesticide by accelerating wetting and delivery of the pesticide from the granules in the presence of water from rain or irrigation. Surfactants may also assist in delivering the pesticide across a greater area of land than would otherwise occur by facilitating leaching of the pesticide and disintegration of the granule.

Surfactants are usually amphiphilic organic compounds. The granular composition preferably comprises a surfactant which aids in providing rapid distribution of the pesticidal active in the presence of water such as from rain or irrigation. The surfactant may be an anionic, cationic, non-ionic, amphoteric surfactant or mixture of two or more thereof. Examples of non-ionic surfactants include alcohol ethoxylates such as C₁₀ to C₁₈ alkyl alcohols ethoxylated with from 2 to 8 ethylene oxide units, such as 014 to 016 alkanols ethoxylated with 5EO units, nonyl phenol ethoxylates such as nonyl phenol with 4 to 8 EO units, tallow amine ethoxylates such as tallow amine with 8 to 12 EO units and EO-PO-EO block copolymers such as block copolymers of molecular weight 1000 to 5000. Other examples include sodium salt of acid resin copolymer (e.g. Tersperse 2700), sodium-N-methyl-N-oleyl taurate (e.g. Geropon T77), sodium polycarboxylate (e.g. Geropon T36) and modified styrene acrylic polymer (e.g. Atlox Metasperse 550S).

The preferred surfactant comprises anionic surfactants including substituted and polymeric alkyl and aryl sulfonates such as sodium alkyl naphthalene sulfonate, sodium napthalene sulfonate, calcium lignosulfonate, sodium lignosulfonate, and ammonium lignosulfonate. A preferred example is sodium lignosulfonate such as available under the trade name “Reax 85A” or “Lignin DS10” (“Redox”).

The carrier component may, in addition to hydratable calcium sulphate, further comprise one or more additional components. The additional carrier can be any of the carriers known in the art of granule formation. Preferred additional carrier components are selected from a range on inorganic materials such as clays, talc, sodium sulphate, pyrophyllite clay, attapulgite clay, kaolin clay, kieselguhr, chalk, diatomaceous earth, lime, calcium carbonate, bentonite clay, Fuller's earth and the like or organics such as urea. The carrier may be chosen from the set consisting of clay, talc, sodium sulphate, silica, attapulgite, kaolin, chalk, limestone, diatomaceous earth, bentonite and urea.

The preferred additional carrier component preferably comprises clay and more preferably kaolinite and present in an amount of up to 80% by weight, preferably from 5% to 75%% by weight of the dry weight of the composition. In one set of embodiments the granules comprise a powdered clay carrier in an amount in the range of from 10% to 60% by weight based on the dry weight of the components. In one embodiment the carrier comprises a relatively minor proportion of silica such as up to 15% (preferably 5% to 10%) by weight of the granule composition.

Urea may be used as a granule component and may bind other components in the presence of moisture.

Examples of the pesticide component of the broadcast granules may be selected from the group consisting of herbicides, insecticides, fungicides, molluscicides, plant growth regulators, nematicides, rodenticides and algicides.

Preferred pesticides include herbicides and insecticides and mixtures thereof.

Specific examples of agrichemical actives include one or more selected from the group consisting of Acetochlor, Allidochlor, Diallate, Metolachlor, Prosulfocarb, Triallate, Trifluralin, Metribuzin, Diuron, bentazone, hexazinone, tebuthiuron, sulfentrazone, imazapic, imazapyr, MSMA, Ametryn, clomazone, isoxaflutole, mesotrione, amicarbazone, atrazine, all forms of 2,4-D, especially salts which are active through root absorption, Pendimethalin, Saflufenacil (Fleabane control—residual many weeds), Flupropanate, Trifludimoxazin, Bacillus thuringiensis, Bendiocarb, chlorpyrifos, Chlorfenapyr, Fipronil, Imidacloprid and Metaldehyde.

The preferred pesticide active has at least some degree of water solubility or water dispersible so as to allow the active to be delivered from the granule when the granule has been deposited at the site of use and contacts water, for example from rain, irrigation or being deposited in a body of water.

In one embodiment the pesticides are chosen from the set consisting of Tebuthiuron, Bacillus thuringiensis, hexazinone, flupropanate.

Preferred insecticides which may be used in the pesticide component of the broadcast granules includes microbial insecticides such as Bacillus thuringiensis (such as Bacillus thuringiensis israelensis), and Bacillus sphericus effective for the control of immature flies such as mosquitoes (Culicidae), aquatic midges (Chironomidae), mushroom flies (Sciaridae). The insecticide Bt (Bacillus thuringiensis) is an example of a preferred insecticide. Bt is thermally labile and the process of the invention allows high activity of Bt to be preserved in the broadcast granules of the invention by allowing granule formation under mild conditions.

In preferred embodiments the moist mixture comprises a pesticide active concentrate in an amount in the range of from 20% to 85% (preferably from 30% to 75%, most preferably from 40% to 60%) by weight based on the dry weight of the components of the composition.

The term pesticide active concentrate may be the most concentrated form of the active agent that is conveniently available to the manufacturer. These concentrates can be highly concentrated such as at least 95% w/w pesticide in the case of organic chemicals or less concentrated such as at least 10% w/w active pesticide in the case of microbial pesticides such as Bt concentrate, which is harvested from a fermentation broth and may be 20% w/w concentrated or even less). In the preferred embodiment the pesticide active is present in an amount of 20% to 85% (preferably from 30% to 75%, most preferably from 40% to 60%) by weight based on the dry weight of the components of the composition. In a more specific preferred embodiments the moist mixture preferably comprises a pesticide selected from tebuthiuron, hexazinone and flupropanate, more preferably tebuthiuron, in an amount in the range of from 20% to 85% (preferably from 30% to 75%, most preferably from 40% to 60%) by weight based on the weight of the total of active and powdered carrier components.

The ratio of active concentrate to hydratable calcium sulfate (preferably the ratio of active per se to calcium sulfate) is typically at least 2:1, preferably at least 3:1, still more preferably at least 4:1 such as at least 6:1 or at least 8:1.

In a preferred set of embodiments the granular composition comprises a hardening accelerator preferably of relatively neutral pH and of relatively low water solubility. In one preference the accelerator moiety comprises calcium sulphate dihydrate. In one embodiment the accelerator comprises ball-milled crystals of calcium sulphate dihydrate, optionally in combination with a surfactant. In one preference, the accelerator moiety is chosen from the group consisting of non-calcium sulphate salts and their non-hydratable hydrates such as fully hydrated zinc sulphate and aluminium sulphate. The hardening accelerator is added in an amount to accelerate hardening in the presence of the hydratable calcium sulfate and water. The amount of accelerator may be determined without undue experiment based on the timing in which hardening is to occur. The accelerator amount in combination with the hydratable calcium sulfate will allow the moist mixture to remain pliable for a time sufficient to allow granule formation but generally allow hardening to a non-pliable state within 240 minutes, preferably within 60 minutes of completion of the granulation process. In one set of embodiments the accelerator is present in an amount to provide a weight ratio of accelerator to anhydrous or partly hydrated calcium sulfate in the range of from 1:10 to 10:1, preferably 1:3 to 3:1.

The active agent is typically suitable for use in broadcast granules and is released from the granule formulation on contact with water. The process is particularly suited to active agents which are active on distribution through soil or water. Pesticides which are solely active via foliar penetration of plants are less useful in the process of the invention.

In one embodiment the granules comprise a combination of pesticides which may be from the same class of pesticides or may be adapted to control different pests such as selected from weeds, insects, molluscs, nematodes, rodents or the like pests.

In one embodiment the granules contain a combination of pesticides selected from flupropanate and tebuthiuron, flupropanate and hexazinone, tebuthiuron and hexazinone or Bt and another insecticide such as methoprene.

In preferred embodiments the moist mixture preferably comprises specialty chemical or bioactive agent in an amount in the range of from 20% to 85% (preferably from 30% to 75%, most preferably from 40% to 60%) by weight based on the weight of the total of active and powdered carrier components.

In one example the process comprises the addition of the water to the powder composition comprising tebuthiuron active agent, calcium sulfate hemihydrate desiccant, gypsum accelerator, sulfate surfactant and carrier (preferably a clay carrier. The weight of components based on the weight of pliable most mixture may comprise:

8% to 20% water;

40% to 60% tebuthiuron;

3% to 6% calcium sulfate hemihydrate

3% to 6% gypsum;

10% to 35% carrier such as clay; and

0% to 15% sulfate surfactant.

In a further set of embodiments there is provided a method of controlling weeds in an area of land comprising applying to the area of land by aerial broadcasting of the granular composition as herein described. The granular composition is typically distributed in dry form from an aircraft such as a fixed wing aeroplane or helicopter.

When the pesticide comprises tebuthiuron or hexazinone the method is useful in weed control on land infested with one or more target weeds selected from the group consisting of brigalow, parkinsonia, prickly acacia, mimosa pigra, black tea tree, broadleaf tea tree, cocky apple, paperbark teatree, poplar gum, swamp box, African boxthorn, coolibah, rubbervine, whitewood, belah, currant bush, lime bush, dawson gum, false sandalwood, hollybush, poplar box, yellow wood, silver leaved ironbark, brown box, gidgee, gum-topped box, groundsel bush, lantana, wild rosemary, gorse and parthenium. In a preferred set of embodiments the weeds are selected from the group consisting of parkinsonia, prickly acacia, brigalow, mimosa pigra and combinations thereof.

In a preferred set of embodiments the weeds have a confined root system such as those selected from the group consisting of gorse, parthenium, sifton bush/Chinese scrub, holly bush, African box thorn, sweet briar, current bush, lime bush, blue heliotrope and combinations thereof.

The composition and method of the invention are particularly useful in control of one or more weeds selected from Brigalow, Parkinsonia, Prickly Acacia and Mimosa Pigra.

We have found that the method is particularly useful in control of weeds of relatively confined root systems such as gorse and parthenium.

We have found that the spheronised particles of uniform size as herein described provide a very significant improvement in weed control, particularly of woody and herbaceous plants and sugar cane, when applied by aerial broadcasting. In particular, the granule composition of the invention provides greater control of granule distribution including more even control of weeds in the area to which the granules are applied and the granules result in fewer “hot spots” with comparatively high concentration of granules than the general area of distribution and fewer areas if inadequate control when compared with known extruded granules of less uniform aspect ratio. Of particular importance is the economy of active application and reduced costs provided by more rapid application in both helicopters and fixed wing aircraft. More economical application can be achieved by allowing aircraft to carry a greater load of active to increase the coverage per load.

The granules may be applied from the ground by hand or land based vehicle or an aircraft. The method of the invention is particularly advantageous when the granules are applied from an aircraft. In one set of embodiments the granules are applied using a helicopter having an application speed of greater than 80 Km/hr and a granule carrying capacity of greater than 200 Kg.

In one set of embodiments the granules are applied using a fixed wing aircraft having an application speed of greater than 150 Km/hr and a granule carrying capacity of greater than 1500 litres.

In one set of embodiments, the granules are broadcast from a drone (pilotless radio-controlled aircraft).

In a further set of embodiments the granules are applied from a fixed-wing aircraft wherein the area treated per hopper load is greater than 150 hectares (preferably greater than 200 hectares and more preferably greater than 210 hectares).

In a set of embodiments the granules are applied from an aircraft wherein the area treated per hopper load is greater than 25 hectares (preferably greater than 30 and more preferably greater than 35 hectares).

The terms wt %, % wt and % w/w are used to refer to amount by weight of a as a percent based on the weight of the composition or of specific components where this is specified.

The invention will now be described with reference to the following examples. It is to be understood that the examples are provided by way of illustration of the invention and that they are in no way limiting to the scope of the invention.

### EXAMPLES

### Examples 1 and 2

The following formulations designated Example 1 and Example 2 (composition as in Table 1) were made into granules using the method of the invention.

TABLE 1

| | Example 1 | Example 2 |
|---|---|---|
| component | (parts by wt) | (parts by wt) |
| Tebuthiuron (96 wt %) | 416.6 | 416.6 |
| Kaolin clay | 321.4 | 316.1 |
| Plaster of Paris | 43.5 | 47.5 |
| *Ball milled | 43.5 | 47.5 |
| accelerator (gypsum) | | |
| Reax 85A | 85.0 | 89.3 |
| Sodium | | |
| lignosulfonate | | |
| Calcium stearate | 30.0 | 33.0 |
| Water (added to | 130 | 140 |
| component blend | | |
| Water (added in | 10 | 10 |
| spheroniser) | | |

*The particle size of the ball milled gypsum was 30 microns to 150 microns.

The granules in Example 1 (after extrusion) had a crush strength of 20 g and a free moisture content of 8% by weight. After 4 hrs storage (ambient conditions, hydration period) the crush strength was 450 g and the free moisture was 5% by weight.

The equipment used included: a Nauta conical screw mixer, a Caleva spheroniser, a basket extruder (including basket, extrusion and chopping blades and collection pan), a grading sieving machine with sieves, and stainless steel trays.

Powder blending was achieved by gradually filling the Nauta conical screw mixer with all the required dry ingredients (see Table 1). The powders were mixed on slow to medium speed for 15 minutes or until uniform in colour.

Water was gradually added to the powder blend whilst mixing at a medium speed setting. Water was added until a loose powdery dough (extrudable crumb) was formed, and the final mixture was fed into a basket extruder to form granules (chopped extrudates).

Spheronisation was achieved by feeding the chopped extrudates (granules) into the spheroniser with the speed of the spinning disc set at 600 rp, and after feeding was complete, the spheroniser disc was allowed to continue spinning for 10 minutes.

The rounded granules from the spheroniser were deposited in shallow trays of 5 cm deep and allowed to sit for 60 minutes.

The dry spheronised granules were fed through the sieving machine to reject out of spec. material.

A sample was taken of the material leaving the basket extruder and measured for moisture. Moisture was measured using NIR methodology (an absolute measure): the granule sample is placed on a tray, IR irradiation is directed at the granules, directly heating free water, and weight loss (associated with water evaporation) is measured. A 4 hr irradiation period was used.

The moisture level is important because if the extrusion mixture is too dry, granule integrity is poor. If the extrusion mixture is too wet, a sticky paste will form which is difficult to extrude and chop. A further sample was taken of the material in the shallow receiving tray to ensure that the free moisture content was in the range 1-3%.

A number of tests were undertaken on the final product as follows:
Appearance—the requirement is spherical granules)
pH (CIPAC MT75.3) (1%)—the requirement is 7.5-8.5)
pour and bulk density (CIPAC MT 186) (g/ml)—The requirement is 0.6-0.9.
Dust content (CIPAC MT171) (%)—The requirement is max 1% less than 50 micron.
Friability and attrition characteristics (CIPAC MT178.2) (%)—the requirement is min 98% retained on 125 micron sieve
Active ingredient concentration (g/kg)—the requirement is 575-625.

Formulations Example 1 and Example 2 passed the above tests. Both formulations yielded greater than 95% of granules of the required size.

### Examples 3 to 5—Broadcast Granules Containing Hexazinone and Tebuthiuron

Broadcast granules are prepared using the general procedure of Examples 1 and 2 with components as listed in Table 2.

TABLE 2

| | Example 3 | Example 4 | Example 5 |
|---|---|---|---|
| Component | Teb 600 | Hex 100 | Hex 400 |
| Tebuthiuron 96% | 625 | — | — |
| Hexazinone 97% | — | 103.1 | 412.4 |
| Kaolin | 107.1 | 524.9 | 215.6 |
| Plaster-of-Paris | 47.5 | 156 | 156 |
| Ball milled | 47.5 | 156 | 156 |
| accelerator | | | |
| (gypsum-based) | | | |
| Reax 85A | 89.3 | — | — |
| Morwet D425 | — | 40 | 40 |
| (sulfonated | | | |
| aromatic polymer) | | | |
| Terwet 1221 | — | 20 | 20 |
| (ethylene diamine | | | |
| alkoxylate) | | | |
| Water added to powder | 140 | 140 | 140 |
| Water added in spheroniser | 10 | 10 | 10 |

### Example 6—Bioefficacy

The granule (Teb 400) described in Example 2 was compared with a commercially available tebuthiuron granule available under the trade name “Regain 200” from Granular Products and contains 200 g/kg of Tebuthiuron).

The granules of Example 2 were applied from a fixed-wing aircraft at 7.3 kg/ha to land infested with Brigalow, Lime Bush and Wait-a-while. The control treatment was 14.6 kg/ha application of Regain 200.

After 1 year, significant and substantially equivalent control of pest weeds was achieved with Teb 400 and “Regain 200”. “Regain 200” is a product of Granular Products Pty Ltd.

1. A process for preparing a broadcast granular pesticide composition comprising:
combining a pesticide active composition, powdered carrier composition and water in an amount of at least 5 wt % water based on the weight of the total of the pesticide active composition and powdered carrier composition, to form a pliable moist mixture; and
forming the pliable moist mixture into granules;
wherein the powdered carrier composition comprises hydratable calcium sulfate whereby hydration of the hydratable calcium sulfate following granule formation reduces the free water content of the granules and produces hardening of the granules.

2. A process according to claim 1 wherein the hydratable calcium sulfate is present in an amount sufficient to achieve an average crush strength of at least 150 g.

3. A process according to any one of the previous claims wherein the hydratable calcium sulfate is present in an amount sufficient to achieve an average crush strength of at least 500 g.

4. A process according to any one of the previous claims, wherein the mixture is of consistency suitable for extrusion or roll extrusion and the granules are formed by extrusion or roll extrusion.

5. A process according to any one of the previous claims, wherein the process of forming the granules comprises extrusion of the mixture followed by rolling of the extrudate to produce rounded granules.

6. A process according to any one of the previous claims where the mixture of pesticide active agent and powdered carrier and optionally some of the water is deposited on a rotating pan, and wherein pliant moist granules are formed with further addition of water in a pan granulation process.

7. A process according to any one of the previous claims, wherein the granules are prepared from the mixture by extrusion followed by spheronisation.

8. A process according to any one of the previous claims wherein the granules are retained in shallow distribution of depth no more than 10 cm, preferably no more than 5 cm, for a period after granule formation to allow hydration to progress until the granules are sufficiently hard for packaging.

9. A process according to any one of the previous claims, wherein the granules have an aspect ratio (largest dimension/smallest dimension) of no more than 1.5, preferably no more than 1.2.

10. A process according to any one of the previous claims, wherein the individual granules have an average density of greater than 1 g/ml, preferably greater than 1.05 g/ml.

11. A process according to any one of the previous claims, wherein the pesticide active composition is in the form of a pesticide active concentrate in an amount in the range of from 20% to 85% (preferably from 30% to 75%, most preferably from 40% to 60%) by weight based on the dry weight of the granule components.

12. A process according to any one of the previous claims, wherein the pesticide active is in an amount in the range of from 20% to 85% (preferably from 30% to 75%, most preferably from 40% to 60%) by weight based on the dry weight of the granule components.

13. A process according to claim 11 wherein the active is a biological pesticide (preferably Bt) present in an amount to provide from 2×10⁶ to 100×10⁶ International Toxicology Units (ITU) per 100 g of granules, preferably from 7.5×10⁶ to 20×10⁶ ITU per 100 g granules.

14. A process according to any one of the previous claims, wherein the hydratable calcium sulfate is present in an amount of from 2% to 25% (preferably from 3% to 25% and more preferably from 4% to 20%) by weight based on the dry weight of the components of the composition.

15. A process according to any one of the previous claims, wherein the ratio of dry weight of the granule components to hydratable calcium sulfate is at least 3:1, preferably at least 4:1, more preferably at 6:1 such as at least 8:1.

16. A process according to any one of the previous claims, wherein the water is added in the mixture in an amount in the range of from 8% to 20% by weight, based on the active and filler weight of the components.

17. A process according to any one of the previous claims, wherein the hydratable calcium sulfate is substantially in the form of the hemihydrate.

18. A process according to any one of the previous claims wherein the powdered carrier comprises an accelerating agent for hydration of the hydratable calcium sulfate, chosen from the set consisting of non-hydratable calcium sulfate such as calcium sulfate dihydrate, non-hydratable non-calcium sulfate salts such as salts based on fully hydrated zinc sulfate and aluminium sulfate.

19. A process according to any one of the previous claims wherein the hydration period is at least 15 minutes and preferably less than 4 hrs.

20. A process according to any one of the previous claims wherein the process is conducted in an environment wherein delta-T, difference between the dry-bulb temperature and the wet-bulb temperature, is in the range of about 2° C. to 8° C.

21. A process according to any one of the previous claims wherein the weight ratio of accelerating agent to calcium sulfate hemihydrate is in the range of 1:10 to 10:1, preferably 1:4 to 4:1 and more preferably 1:2 to 2:1.

22. A process according to any one of the previous claims wherein the granules further comprise a powdered clay carrier in an amount in the range of from 10% to 60% by weight based on the weight of the active and filler components.

23. A process according to any one of the previous claims wherein the pesticide is selected from the group consisting of herbicides, insecticides, fungicides, molluscicides, plant growth regulators, nematicides, rodenticides and algicides.

24. A process according to any one of the previous claims wherein the pesticide is a herbicide.

25. A process according to any one of the previous claims wherein the pesticide is selected from the group consisting of tebuthiuron, Bacillus thuringiensis, hexazinone and flupropanate.

26. A process according to any one of the previous claims wherein the pesticide is selected from the group consisting of tebuthiuron, hexazinone and flupropanate present in an amount of from 20% to 85% (preferably from 30% to 75%, most preferably from 40% to 60%) by weight based on the dry weight of the granule components.

27. A process according to any one of the previous claims wherein the granular composition comprises a surfactant which is selected from sulfonate surfactants.

28. A process for controlling pests in an area of land comprising pests comprising broadcasting dry granules according to any one of the previous claims onto the land.

29. A process according to any one of the previous claims wherein the granular composition is broadcast from an aircraft.

30. A process according to claim 28, wherein the granular composition is broadcast from a drone.

31. The process of any one of the previous claims wherein the process comprises the addition of the water to the powder composition comprising tebuthiuron active agent, calcium sulfate hemihydrate desiccant, gypsum accelerator, sulfate surfactant and carrier (preferably a clay carrier).

32. The process of claim 31 wherein the weight of components based on the weight of pliable most mixture comprises:
8% to 20% water;
40% to 60% tebuthiuron;
3% to 6% calcium sulfate hemihydrate
3% to 6% gypsum;
10% to 35% carrier such as clay; and
0% to 15% sulfate surfactant.
